(19) United States
(12) Patent Application Publication
(10) Pub. No.: US 2005/0182172 A1
(43) Pub. Date: Aug. 18, 2005

(54) Particulate alumina, method for producing particulate alumina and composition containing particulate alumina

(76) Inventors: Katsuhiko Kamimura, Kanagawa (JP); Susumu Shibusawa, Kanagawa (JP)

Correspondence Address: SUGHRUE MION, PLLC, 2100 PENNSYLVANIA AVENUE, N.W., SUITE 800, WASHINGTON, DC, 20037, US

(21) Appl. No.: 10/500,010

(22) PCT Filed: Dec. 27, 2002
(86) PCT No.: PCT/JP02/13762

Related U.S. Application Data
(60) Provisional application No. 60/345,654, filed on Jan. 8, 2002.

(30) Foreign Application Priority Data
Dec. 27, 2001 (JP) 2001-396221

(51) Int. Cl. C01F 7/02; C08K 3/18

(52) U.S. Cl. 524/430; 423/625

(57) ABSTRACT

Particulate alumina has a mean particle size corresponding to a volume-cumulative 50% mean particle size (D50) falling within a range of 3 to 6 μm, has a ratio of D90 to D10 that is 2.5 or less, contains particles that have a particle size of at least 12 μm in an amount of 0.5 mass % or less, particles that have a particle size of 20 μm or more in an amount of 0.01 mass % or less and particles that have a particle size of 1.5 μm or less in an amount of 0.2 mass % or less, and contains an α-phase as a predominant phase. In addition, the particulate alumina has a ratio of longer diameter (DL) to shorter diameter (DS) that is 2 or less and a ratio of D50 to mean primary particle size (DP) that is 3 or less. With these features, the particulate alumina has a narrow particle size distribution profile, causes little wear and exhibits excellent flow characteristics.

### CROSS REFERENCE TO RELATED APPLICATIONS

This application is an application filed under 35 U.S.C. §111(a) claiming the benefit pursuant to 35 U.S.C. §119(e)(1) of the filing date of provisional Application No. 60/345,654 filed Jan. 8, 2002 pursuant to 35 U.S.C. 111(b).

### TECHNICAL FILED

The present invention relates to particulate alumina and to an industrial, economical method for producing particulate alumina which is particularly useful for materials, such as substrate material and sealing material for electronic parts, fillers, finish lapping material and aggregates incorporated into refractory, glass, ceramic, or composites thereof; has a narrow particle size distribution profile (i.e., containing few coarse particles and microparticles); causes little wear; and exhibits excellent flow characteristics. The invention also relates to particulate alumina produced through the method and to a composition containing the particulate alumina.

### BACKGROUND ART

In recent years, electronic parts used in apparatus for advanced telecommunication of information (e.g., telecommunication via multimedia) have been required to be adapted to modularization and higher-speed, higher-frequency operation in order to fully accomplish such telecommunication. Thus, improvement of electric characteristics, such as lowering of dielectric constant, is a critical issue in development of such apparatus. In addition, demands for higher integration and higher density of electronic parts have elevated electric power consumption per chip. Thus, effective removal of generated heat in order to suppress temperature elevation of electronic elements is also a critical issue. In view of the foregoing, alumina, particularly corundum (α-alumina), which exhibits a narrow particle distribution profile and excellent thermal conductivity, has become a candidate filler for a heat-dissipation spacer, a substrate material on which insulating sealing materials for semiconductors and parts of semiconductor devices are mounted, etc., and modification of alumina has been effected in a variety of fields.

Among such corundum particles, JP-A SHO 62-191420 discloses spherical corundum particles having no fractures and a mean particle size of 5 to 35 μm, the particles being produced by adding aluminum hydroxide and optionally other known agents serving as crystallization promoters in combination to a pulverized product of alumina, such as electrofused alumina or sintered alumina, and firing the mixture.

The prior art also discloses that roundish corundum particles having a mean particle size of 5 μm or less can be produced through a known method including addition of a crystal growth agent to aluminum hydroxide.

Specifically, JP-A HEI 5-43224 discloses that spherical alumina particles can be produced by heating aluminum hydroxide at 700° C. or lower to sufficiently cause dehydration and pyrolysis, elevating the temperature of the resultant heated product to yield a fired intermediate having an a ratio of 90% or higher and firing the fire intermediate in the presence of a fluorine-containing hardening agent.

There has also been known a thermal spraying method in which alumina produced through the Bayer method is jetted into high-temperature plasma or oxygen-hydrogen flame to thereby produce roundish crystal particles through melting and rapid quenching. However, the thermal spraying method has a drawback that unit heat energy requirement is large, resulting in high costs. In addition, the thus produced alumina, although predominantly containing α-alumina, includes by-products, such as δ-alumina. Such an alumina by-product is not preferred since the product exhibits low thermal conductivity.

Pulverized products of electrofused alumina or sintered alumina have also been known as corundum particles. However, these corundum particles are of indefinite shape having sharp fractures and produce significant wear in a kneader, a mold, etc. during incorporation thereof into rubber/plastic. Thus, these corundum particles are not preferred.

Electronic parts used in a cellular phone or in a similar apparatus are required to be adapted to modularization and higher-speed, higher-frequency operation. A multi-layer substrate used in the apparatus, particularly a glass-ceramic substrate, having a low dielectric constant is particularly advantageous from the viewpoint of, for example, conductor loss of wiring and incorporation of a passive part in the substrate. However, the glass-ceramic substrate is inferior to an alumina-ceramic substrate in terms of properties, such as mechanical strength and dielectric loss. In order to ensure enhanced characteristics of the glass-ceramic substrate, particulate alumina having a roundish shape and a smaller particle size, exhibiting a narrow particle size distribution profile and containing an active chemical component must be used as a filler. These features cannot be attained by conventionally employed alumina.

However, since the smaller the particle size, the higher the self-cohesion force, fluidity is deteriorated upon incorporation of microparticles into glass, rubber or plastic, and the microparticles form agglomerated particles in the resultant glass, rubber or plastic composition, possibly lowering mechanical strength and thermal conductivity. Thus, a limitation is also imposed on the decrease in particle size of microparticles.

The particulate alumina disclosed in JP-A HEI 6-191833 has a shape for suitably serving as filler for a rubber/plastic composition. However, since the above particulate alumina is produced through a special process called in-situ CVD, the production cost thereof is considerably high as compared with particulate alumina produced through other methods, resulting in a disadvantage in terms of economy. In addition, the above particulate alumina has a drawback in its characteristics, i.e., broad particle size distribution profile.

The particulate alumina disclosed in JP-A SHO 62-191420 has a coarse particle size and an excessively large maximum particle size, and the particulate alumina disclosed in JP-A HEI 5-43224 has a drawback in that particles thereof strongly agglomerate to thereby broaden the particle size distribution profile of the crushed product.

An object of the present invention is to provide a method for industrially inexpensively producing particulate alumina that has a narrow particle size distribution profile, contains few coarse particles and microparticles, causes little wear and exhibits excellent flow characteristics, provide particulate alumina produced through the method, and provide a composition containing the particulate alumina.

### DISCLOSURE OF THE INVENTION

The present invention provides particulate alumina having a mean particle size corresponding to a 50% cumulative volume as determined from a particle size distribution curve (hereinafter simply referred to as a “volume-cumulative 50% mean particle size (D50)”) falling within a range of 3 to 6 μm, having a ratio of D90 to D10 that is 2.5 or less, containing particles that have a particle size of at least 12 μm in an amount of 0.5 mass % or less, particles that have a particle size of 20 μm or more in an amount of 0.01 mass % or less and particles that have a particle size of 1.5 μm or less in an amount of 0.2 mass % or less, and containing an α-phase as a predominant phase.

The particulate alumina includes particulate alumina having a ratio of longer diameter (DL) to shorter diameter (DS) that is 2 or less and a ratio of D50 to mean primary particle size (DP) that is 3 or less.

The particulate alumina includes particulate alumina containing Na₂O in an amount of 0.1% or less, B in an amount of at least 80 ppm and CaO in an amount of at least 500 ppm.

The invention further provides a method for producing particulate alumina that comprises the steps of adding, to aluminum hydroxide or alumina, a boron compound, a halide and a calcium compound to form a mixture and firing the mixture.

In the method, the halide is at least one species selected from the group consisting of aluminum halide, ammonium halide, calcium halide, magnesium halide and hydrogen halide.

In the method, the boron compound is at least one species selected from among boric acid, boron oxide and borate salts.

In the method, the halide is at least one species selected from the group consisting of aluminum fluoride, aluminum chloride, ammonium chloride, ammonium fluoride, calcium fluoride, calcium chloride, magnesium chloride, magnesium fluoride, hydrogen fluoride and hydrogen chloride.

In the method, the calcium compound is at least one species selected from the group consisting of calcium fluoride, calcium chloride, calcium nitrate and calcium sulfate.

In the method, the boron compound is added in an amount, as reduced to boric acid, falling within a range of 0.05 to 0.50 mass % based on alumina; the calcium compound is added in an amount, as reduced to Ca, falling within a range of 0.03 to 0.10 mass % based on alumina; and the halide is added in an amount falling within a range of 0.20 to 0.70 mass % based on alumina.

In the method, wherein the step of firing is performed at a temperature falling within a range of 1,200 to 1,550° C. and for a maximum temperature retention time falling within a range of 10 minutes to 10 hours.

The method further comprises the step of crushing the fired mixture by means of an airflow pulverizer employing a nozzle jet gauge pressure falling within a range of 2×10⁵ Pa to 6×10⁵ Pa or by means of a ball mill or a vibration mill employing alumina balls, followed by the step of removing microparticles by use of an airflow classifier.

The invention further provides a composition containing particulate alumina in an amount of at least 10 mass % and not greater than 90 mass %.

The composition further comprises a polymer filled with the particulate alumina, and the polymer is at least one species selected from aliphatic resin, unsaturated polyester resin, acrylic resin, methacrylic resin, vinyl ester resin, epoxy resin and silicone resin.

In the composition, the polymer is an oily substance and has a softening point or a melting point falling within a range of 40 to 100° C.

The invention further provides an electronic part or a semiconductor device containing the composition between a heat source and a radiator.

Since the particulate alumina of the present invention has a volume-cumulative 50% mean particle size (D50) falling within a range of 3 to 6 μm, the flow characteristics are enhanced. In addition, since it has a ratio of D90 to D10 that is 2.5 or less, the particle size distribution profile becomes narrow to reduce the ratio of mixed coarse particles and microparticles. Furthermore, since it contains an α-phase as a predominant phase, it is advantageously used as a filler, such as substrate material, sealing material or finish-lapping material for electronic parts, or aggregates of refractory material, glass, ceramic, or a composite of these.

Moreover, since the method of the present invention only requires the firing temperature of 1,550° C. or less to produce particulate alumina and the temperature retention time need not exceed 10 hours, the method is economical and can be performed with ease.

### BEST MODE FOR CARRYING OUT THE INVENTION

The particulate alumina of the present invention has a volume-cumulative 50% mean particle size (D50) falling within a range of 3 to 6 μm, has a ratio of D90 to D10 that is 2.5 or less, contains particles having a particle size of at least 12 μm in an amount of 0.5 mass % or less, particles having a particle size of at least 20 μm in an amount of 0.01 mass % or less and particles having a particle size of 1.5 μm or less in an amount of 0.2 mass % or less, and contains an α-phase as a predominant phase.

The phrase “an α-phase contained as a predominant phase” refers to the α-phase content of at least 95 mass %, preferably at least 98 mass %. The α-phase content is determined in the following manner.

X-ray diffractometry of particulate alumina is performed under the following conditions: target of Cu.Kα; slit of 0.3 mm; scan speed of 2°/min; and scan range of 2θ=10 to 70°.

α-Phase content is derived from the equation: α-Phase content=[(A-C)/{(A-C)+(B-C)}]×100, wherein A denotes a peak height (α-alumina) at 2θ=68.2°, B denotes a peak height (κ-alumina) at 2θ=63.1°, and C denotes a base line height at 2θ=69.5°.

The volume-cumulative mean particle size of the present invention can be determined by means of any known particle size distribution measuring apparatus. Preferably, the size is measured, for example, by use of a laser diffraction particle size distribution measuring apparatus. Preferably, particles of a certain size (e.g., 20 μm) are determined by hydraulic classification performed under ultrasonic dispersion by use of an ultramicro-particle classifier and by confirmation of the amount of particles remaining on a sieve.

Such particulate alumina serves as alumina particles that are particularly suitable for filler added to a glass-ceramic composition. D50 must fall within a range of 3 to 6 μm, and preferably falls within a range of 3.5 to 4.5 μm. The particle size of alumina is preferably equivalent to that of glass frit serving as a predominant material of the glass-ceramic composition. When D50 is in excess of 6 μm or less than 3 μm, the substrate has poor mechanical strength, thereby deteriorating characteristics. D90/D10 must be controlled to 2.5 or less, and is preferably 2.2 or less. When D90/D10 is in excess of 2.5, the particle size distribution profile is broadened, thereby failing to attain uniformity in reaction between glass and alumina particles, and in turn lowering the mechanical strength of the substrate. When the amount of particles having a particle size of at least 12 μm exceeds 0.5 mass % or the amount of particles having a particle size of at least 20 μm exceeds 0.01 mass %, the substrate has poor dielectric strength. When the amount of particles having a particle size of 1.5 μm or less exceeds 0.2 mass %, flowability of the composition is deteriorated, and dielectric loss increases.

The particulate alumina of the present invention preferably has a ratio of longer diameter (DL) to shorter diameter (DS) that is 2 or less and a ratio of D50 to mean primary particle size (DP) that is 3 or less, because such particulate alumina is suitable as a filler to be added to a glass-ceramic composition.

When DL/DS is in excess of 2, the particle shape becomes flat, thereby deteriorating mechanical strength of the substrate and thermal conductivity of the composition. When D50JDP is in excess of 3, alumina particles are quasi-agglomerated, thereby deteriorating mechanical strength of the substrate and flowability of the composition.

In the present invention, the longer diameter and shorter diameter of alumina particles are determined through photographic analysis of secondary electron images observed under a scanning electron microscope (SEM). The mean primary particle size is calculated from the BET specific surface area on the basis of the following equation: primary particle size (μm)=6/{true density of alumina×BET specific surface area (m²/g)}, wherein the true density of alumina is 3.987 g/cm³. The BET specific surface area is determined through the nitrogen adsorption method.

The particulate alumina of the present invention contains Na₂O in an amount of 0.1% or less, preferably 0.05% or less. When the Na₂O content is in excess of 0.1%, sintering characteristics are deteriorated, thereby lowering reliability of insulating material. The B content is at least 80 ppm, preferably at least 100 ppm, and the CaO content is at least 500 ppm, preferably at least 800 ppm. B or CaO serves as an effective sintering aid for sintering a glass-ceramic material. Particularly, B or CaO promotes liquid-phase sintering in the grain boundary between glass matrix and particulate alumina, thereby enhancing mechanical strength of the substrate.

The particulate alumina of the present invention can be produced through a method comprising adding a boron compound, a halide and a calcium compound to a raw material powder to form a mixture and firing the mixture. Aluminum hydroxide or alumina is used as a raw material powder. However, a mixed powder containing aluminum hydroxide and alumina or a mixed powder of aluminum hydroxide and alumina can also be used.

When employed as a raw material powder, alumina preferably has a BET specific surface area falling within a range of 10 to 30 m²/g. No particular limitation is imposed on the ratio of the amount of alumina to that of aluminum hydroxide contained in the mixed powder. An alumina BET specific surface area of 10 m²/g or less, particularly of less than 5 m²/g, is not preferred for growth of α crystal grains during firing. Accordingly, the BET specific surface area preferably falls within the above range.

Preferably employed boron compounds include boric acid, boron oxide and borate salts. Examples of preferably employed halides include at least one species selected from the group consisting of aluminum halide, ammonium halide, calcium halide, magnesium halide and hydrogen halide. Of these, aluminum fluoride, aluminum chloride, ammonium chloride, ammonium fluoride, calcium fluoride, calcium chloride, magnesium chloride, magnesium fluoride, hydrogen fluoride and hydrogen chloride are more preferably employed. Examples of preferably employed calcium compounds include calcium fluoride, calcium chloride, calcium nitrate and calcium sulfate.

The boron compound, halide and calcium compound may be added individually. Alternatively, a single substance that serves as two or three members of these three compounds may be used. For example, addition of a calcium halide is equivalent to addition of the halide and calcium compound of the present invention. Addition of a halide containing both boron and calcium is equivalent to addition of the boron compound, halide and calcium compound of the present invention.

According to the method of the present invention for producing particulate alumina, the boron compound is preferably added in an amount, as reduced to boric acid, falling within a range of 0.05 to 0.5 mass % based on alumina, more preferably 0.1 to 0.4 mass %. The halide is preferably added in an amount falling within a range of 0.2 to 0.7 mass % based on alumina, more preferably 0.3 to 0.6 mass %. The calcium compound is preferably added in an amount, as reduced to Ca, falling within a range of 0.03 to 0.1 mass % based on alumina, more preferably 0.04 to 0.07 mass %. The amounts of the respective added compounds that are lower than the lower limits of the corresponding ranges are not preferred since roundish alumina particles fail to be grown. The amounts of the respective added compounds that are higher than the upper limits of the corresponding ranges are also not preferred since the effect of the present invention, i.e., provision of particulate alumina suitable as a filler added to a glass-ceramic composition, is no longer enhanced and because such an excess amount is not preferred from the viewpoint of economy.

When the boron compound, halide and calcium compound are added individually, the compounds are preferably added in amounts falling within the above ranges. When a single substance that serves as two or three members of these three compounds is added, addition is performed in the following manner. For example, when a calcium halide is added, the amount of the calcium compound to be added is calculated from the Ca content based on alumina, and the amount of the halide to be added is calculated from the amount of the calcium halide added. When a halide containing both boron and calcium is added, the amount of the boron compound to be added is calculated from the boric acid content based on alumina, the amount of the calcium compound to be added is calculated from the Ca content based on alumina, and the amount of the halide to be added is calculated from the amount of the added halide containing both boron and calcium.

Preferably, in the present invention, firing is performed within a temperature range of 1,200° C. to 1,550° C. and for a maximum temperature retention time falling within a range of 10 minutes to 10 hours. More preferably, the firing temperature is controlled to 1,350° C. to 1,500° C., and the maximum temperature retention time falls within a range of 30 minutes to 8 hours.

When the firing temperature is lower than 1,200° C., α-phase does not form in particulate alumina, which is not preferred, and when the maximum temperature retention time is shorter than 10 minutes, growth of alumina particles is inhibited, which is not preferred. Even when the firing temperature is in excess of 1,550° C. or the retention time is longer than 10 hours, the effect of the invention is no longer enhanced, which is not preferred, from the viewpoint of economy. No particular limitation is imposed on the type of the heating furnace employed for firing, and known means, such as a single kiln, a tunnel kiln or a rotary kiln may be employed.

Preferably, the method of the present invention for producing particulate alumina comprises adding a boron compound, a halide and a calcium compound to aluminum hydroxide, alumina or a mixture of aluminum hydroxide and alumina to form a mixture; firing the mixture to yield alumina particles; and crushing the yielded alumina particles by means of an airflow pulverizer employing a nozzle jet gauge pressure falling within a range of 2×10⁵ Pa to 6×10⁵ Pa (2 to 6 kgf/cm²) or by means of a ball mill or a vibration mill employing alumina balls, followed by removal of microparticles by use of an airflow classifier. Preferably, the airflow pulverizer employs a nozzle jet gauge pressure falling within a range of 3×10⁵ Pa to 5×10⁵ Pa. When the airflow pulverizer is employed, flow of air, amounts of raw materials fed and rotation rate of a classifier incorporated in the airflow pulverizer are appropriately adjusted such that the crushed particulate alumina exhibits a predetermined maximum particle size. When the nozzle jet pressure is lower than 2×10⁵ Pa, crushing efficiency lowers, whereas when the nozzle jet pressure is higher than 6×10⁵ Pa, the degree of pulverization increases excessively, thereby inhibiting provision of the particulate alumina of the present invention suitable as a filler to be added to a glass-ceramic composition. Alumina balls used in a ball mill or a vibration mill preferably have a size of 10 to 25 mmφ. When a ball mill is employed, crushing time, which depends on the scale and performance of the pulverizer, typically falls within a range of 180 minutes to 420 minutes. The thus crushed powder often contains excessively pulverized ultramicro-particles. Such particles are preferably removed by use of an airflow classifier.

The particulate alumina produced through the method of the present invention is incorporated into a glass frit made of borosilicate glass, MgO—Al₂O₃—SiO₂ glass, CaO—Al₂O₃—SiO₂ glass, etc. to thereby suitably provide a glass-ceramic composition. Preferably, the glass-ceramic composition contains the particulate alumina in an amount falling within a range of 10 mass % to 90 mass %. When the particulate alumina content in the composition increases excessively, firing temperature of glass ceramic must be raised, thereby deteriorating dielectric constant, whereas when the particulate alumina content lowers excessively, mechanical strength of the substrate lowers. Thus, more preferably, the particulate alumina content falls within a range of 20 mass % to 60 mass %. Since the content of particulate alumina affects firing temperature of glass ceramic and mechanical strength of a material formed of the glass ceramic, the content is preferably selected such that the resultant material exhibits characteristics in accordance with purposes.

The particulate alumina produced through the production method of the present invention is preferably incorporated into polymers, such as oil, rubber and plastic, whereby a high-thermal-conductivity grease composition, a high-thermal-conductivity rubber composition and a high-thermal-conductivity plastic composition are provided. The particulate alumina is particularly preferably contained in an amount of at least 80 mass %.

Any known polymer can be employed as a polymer constituting the resin composition of the present invention. Examples of preferred polymers include aliphatic resin, unsaturated polyester resin, acrylic resin, methacrylic resin, vinyl ester resin, epoxy resin and silicone resin.

These resins may have low molecular weight or high molecular weight. The form of these resins can be arbitrarily determined in accordance with purposes and circumstances of use, and may be oil-like liquid, rubber-like material or hardened products.

Examples of the resins include hydrocarbon resins {e.g., polyethylene, ethylene-vinyl acetate copolymer, ethylene-acrylate copolymer, ethylene-propylene copolymer, poly(ethylene-propylene), polypropylene, polyisoprene, poly(isoprene-butylene), polybutadiene, poly(styrene-butadiene), poly(butadiene-acrylonitrile), polychloroprene, chlorinated polypropylene, polybutene, polyisobutylene, olefin resin, petroleum resin, styrol resin, ABS resin, coumarone-indene resin, terpene resin, rosin resin and diene resin}; (meth)acrylic resins {e.g., homopolymers and copolymers produced from methyl (meth)acrylate, ethyl (meth)acrylate, 2-ethylhexyl (meth)acrylate, n-nonyl (meth)acrylate, (meth)acrylic acid, and/or glycidyl (meth)acrylate; polyacrylonitrile and copolymers thereof polycyanoacrylate; polyacrylamide; and poly(meth)acrylic acid salts}; vinyl acetate resins and vinyl alcohol resins {e.g., vinyl acetate resin, polyvinyl alcohol, polyvinyl acetal resin and polyvinyl ether}; halogen-containing resins {e.g., vinyl chloride resin, vinylidene chloride resin, fluororesin}; nitrogen-containing vinyl resins {e.g., poly(vinylcarbazole), poly(vinylpyrrolidone), poly(vinylpyridine) and poly(vinylimidazole)}; diene polymers {e.g., butadiene-based synthetic rubber, chloroprene-based synthetic rubber and isoprene-based synthetic rubber}; polyethers {e.g., polyethylene glycol, polypropylene glycol, hydrin rubber and penton resin}; polyethyleneimine resins; phenolic resins {e.g., phenol-formalin resin, cresol-formalin resin, modified phenolic resin, phenol-furfural resin and resorcin resin}; amino resins {e.g., urea resin and modified urea resin, melamine resin, guanamine resin, aniline resin and sulfonamide resin}; aromatic hydrocarbon resins {e.g., xylene-formaldehyde resin, toluene-formalin resin}; ketone resins {e.g., cyclohexanone resin and methyl ethyl ketone resin}; saturated alkyd resin; unsaturated polyester resins {e.g., maleic anhydride-ethylene glycol polycondensate and maleic anhydride-phthalic anhydride-ethylene glycol polycondensate}; allyl phthalate resins {e.g., unsaturated polyester resin crosslinked with diallyl phthalate}; vinyl ester resins {e.g., resin produced by crosslinking with styrene, an acrylic ester, etc. a primary polymer having a bisphenol A ether bond and highly reactive terminal acrylic double bonds}; allyl ester resins; polycarbonates; polyphosphate ester resins; polyamide resins; polyimide resins; silicone resins {e.g., silicone oil, silicone rubber and silicone resin derived from polydimethylsiloxane, and reactive silicone resin which has in its molecule a hydrosiloxane, hydroxysiloxane, alkoxysiloxane or vinylsiloxane moiety and which is cured by heat or in the presence of a catalyst}; furan resins; polyurethane resins; polyurethane rubbers; epoxy resins {e.g., bisphenol A-epichlorohydrin condensate, novolak phenolic resin-epichlorohydrin condensate, polyglycol-epichlorohydrin condensate}; phenoxy resins; and modified products of these. These resins may be used singly or in combination of a plurality of species.

These polymers may have low molecular weight or high molecular weight. The form of these resins can be arbitrarily determined in accordance with purposes and circumstances of use, and may be oil-like liquid, rubber-like material or hardened products.

Of these, unsaturated polyester resin, acrylic resin, methacrylic resin, vinyl ester resin, epoxy resin and silicone resin are preferably used.

More preferably, the polymer is an oily substance since grease prepared by mixing particulate alumina and oil conforms to the corrugated surface configuration of a heat source and that of a radiator included in an electronic device and reduces the distance therebetween, thereby enhancing heat dissipation effect.

No particular limitation is imposed on the type of oil that can be used in the present invention, and any oil species can be employed. Examples include silicone oil, petroleum-based oil, synthetic oil and fluorine-containing oil.

Preferably, in order to facilitate handling of the thermal conductive composition, the oil is a polymer that assumes a sheet-like shape at room temperature and becomes greasy when softened or melted as temperature elevates. No particular limitation is imposed on such a type of oil, and those known in the art can be employed. Examples include thermoplastic resins, low-molecular weight species thereof and thermoplastic resin compositions whose softening point or melting point has been modified by blending oil. The softening point or melting point, varying depending on the temperature of a heat source, preferably falls within a range of 40° C. to 100° C.

The aforementioned thermal conductive resin is inserted between a heat source of an electronic part or semiconductor device and a radiator, such as a radiation plate, thereby effectively dissipating generated heat, suppressing thermal deterioration and other types of deterioration of the electronic part or semiconductor device, reducing the incidence of malfunctions and prolonging the service life thereof No particular limitation is imposed on the electronic parts and semiconductor devices, and examples include computer's central processing units (CPUs), plasma displays (PDPs), secondary batteries and the relating peripheral apparatus (e.g., an apparatus disposed in a hybrid electric vehicle or the like for stabilizing cell characteristics by controlling temperature through provision of the aforementioned thermal conductive composition between a secondary battery and a radiator), radiators for motors, Peltier's devices, inverters and (high) power transistors.

The present invention will next be described in detail by way of Examples and Comparative Examples, which should not be construed as limiting the invention thereto.

### EXAMPLE 1

Boric acid (0.2 mass %), aluminum fluoride (0.03 mass %), calcium fluoride (0.1 mass %) and ammonium chloride (0.4 mass %) were added to alumina (BET value: 20 m²/g), and the resultant mixture was fired at 1,450° C. for four hours.

After completion of firing, the fired product was removed and crushed by means of an airflow pulverizer at a nozzle jet gage pressure of 5×10⁵ Pa. Through X-ray diffractometry, the crushed particulate product was found to be alumina having an α-phase content of 95%. The BET specific surface area of the thus produced particulate alumina was determined through the nitrogen adsorption method. The volume-cumulative mean particle size and the particle size distribution of the particulate alumina were obtained by use of sodium hexametaphosphate serving as a dispersant and by means of a laser diffraction particle size distribution measuring apparatus (Microtrack HRA, a product of Nikkiso). The amount of 20-μm-particles was determined by performing hydraulic classification by use of an ultramicro-particle classifier (Shodex-Ps) having a 20-μm sieve under ultrasonic dispersion by means of an ultrasonic washer (CH-30S-3A, Shimada Rika), transferring the residue remaining on the sieve to filter paper, dehydrating the residue by use of a drying apparatus and measuring the dried residue by means of an even balance. The longer and shorter particle sizes of the particulate alumina were determined from an SEM photograph. The primary particle size was calculated from the BET specific surface area on the basis of the aforementioned conversion equation.

### EXAMPLES 2 to 6 AND COMPARATIVE EXAMPLES 1 to 4

In each case, particulate alumina was produced under the conditions shown in Table 1. In Example 2 and Comparative Examples 1, 2 and 4, crushing was performed by use of a ball mill. In Example 2, microparticles were removed, after crushing, by use of an airflow classifier. Other conditions not shown in Table 1 were the same as those employed in Example 1. The material characteristics, firing conditions and crushing condition are shown in Table 1, and evaluation results of the thus obtained particulate alumina products are shown in Table 2.

### EXAMPLE 7

The particulate alumina powder obtained in Example 1 (40 parts by mass) and borosilicate glass powder (60 parts by mass) were mixed, with a solvent (ethanol/toluene) and an acrylic binder added, to thereby yield slurry. The slurry was formed into a green sheet through the doctor blade method. The green sheet was sintered at 1,000° C. to thereby yield a ceramic sheet. The flexural strength of the ceramic sheet was determined through the method described in JIS R1601. The evaluation result is shown in Table 3.

### EXAMPLE 8

The procedure of Example 7 was repeated, except that the particulate alumina of Example 1 was replaced with that of Example 2, to thereby obtain a ceramic sheet. The flexural strength of the sheet was determined, and the evaluation result is shown in Table 3.

### COMPARATIVE EXAMPLE 5

The procedure of Example 7 was repeated, except that the particulate alumina of Example 1 was replaced with that of Comparative Example 1, to thereby obtain a ceramic sheet. The flexural strength of the sheet was determined, and the evaluation result is shown in Table 3.

### COMPARATIVE EXAMPLE 6

The procedure of Example 7 was repeated, except that the particulate alumina of Example 1 was replaced with that of Comparative Example 2, to thereby obtain a ceramic sheet. The flexural strength of the sheet was determined, and the evaluation result is shown in Table 3.

### EXAMPLE 9

Silicone oil (KF96-100, a product of Shin-Etsu Chemical Co., Ltd.) (20 parts by mass) was added to the particulate alumina of Example 1 (80 parts by mass), and the resultant mixture was stirred by means of a planetary stirring-defoaming apparatus (KK-100, a product of Kurabo Industries Ltd.) to thereby yield grease. The thermal resistance of the thus yielded grease was determined by use of an apparatus fabricated in accordance with American Society for Testing and Materials (ASTM) D5470. The evaluation result is shown in Table 4.

### EXAMPLE 10

The procedure of Example 9 was repeated, except that silicone oil (KF96-100, a product of Shin-Etsu Chemical Co., Ltd.) (20 parts by mass) was added to the particulate alumina (80 parts by mass) produced in Example 2, to thereby yield grease. The thermal resistance of the grease was determined. The evaluation result is shown in Table 4.

### COMPARATIVE EXAMPLE 7

The procedure of Example 9 was repeated, except that silicone oil (KF96-100, a product of Shin-Etsu Chemical Co., Ltd.) (20 parts by mass) was added to the particulate alumina (80 parts by mass) produced in Comparative Example 1, to thereby yield grease. The thermal resistance of the grease was determined. The evaluation result is shown in Table 4.

### COMPARATIVE EXAMPLE 8

The procedure of Example 9 was repeated, except that silicone oil (KF96-100, a product of Shin-Etsu Chemical Co., Ltd.) (20 parts by mass) was added to the particulate alumina (80 parts by mass) produced in Comparative Example 2, to thereby yield grease. The thermal resistance of the grease was determined. The evaluation result is shown in Table 4.

TABLE 1

| | | | Firing | | | | | |
|---|---|---|---|---|---|---|---|---|
| | | | Amount of added compound (mass %) based on alumina | | | | | |
| | Material characteristics | | | | | Calcium | | |
| | | BET | | Halide | | compound | Crushing | |
| | | value | Boron compound | Aluminum | Aluminum | Calcium | | Airflow |
| | | (m²/g) | Boric acid | fluoride | chloride | fluoride | Crushing | classifier |
| Ex. 1 | Alumina | 20 | 0.2 | 0.03 | 0.4 | 0.1 | Airflow | — |
| | | | | | | | pulverizer | |
| Ex. 2 | Alumina | 20 | 0.2 | 0.03 | 0.4 | 0.1 | Ball mill | Performed |
| Ex. 3 | Alumina | 20 | 0.2 | 0.03 | 0.4 | 0.1 | Airflow | — |
| | | | | | | | pulverizer | |
| Ex. 4 | Alumina | 20 | 0.3 | 0.03 | 0.4 | 0.1 | Airflow | — |
| | | | | | | | pulverizer | |
| Ex. 5 | Aluminum | — | 0.2 | 0.03 | 0.4 | 0.1 | Airflow | — |
| | hydroxide | | | | | | pulverizer | |
| Ex. 6 | Mixture | — | 0.2 | 0.03 | 0.4 | 0.1 | Airflow | — |
| | | | | | | | pulverizer | |
| Comp. | Alumina | 20 | 0.3 | 0.05 | 0 | 0 | Ball mill | Not |
| Ex. 1 | | | | | | | | performed |
| Comp. | Alumina | 20 | 0 | 0.04 | 0.6 | 0 | Ball mill | Not |
| Ex. 2 | | | | | | | | performed |
| Comp. | Alumina | 20 | 0.3 | 0.05 | 0 | 0 | Airflow | — |
| Ex. 3 | | | | | | | pulverizer | |
| Comp. | Alumina | 20 | 0.2 | 0.03 | 0.4 | 0.1 | Ball mill | Not |
| Ex. 4 | | | | | | | | performed |

TABLE 2

| | Product characteristics | | | | | | | | | | | |
|---|---|---|---|---|---|---|---|---|---|---|---|---|
| | | | | | | ≧20 μm- | ≧12 μm- | ≦1.5 μm- | | | | |
| | | | | | | particle | particle | particle | | | | |
| | BET value | DP | D50 | | | content | content | content | | Na₂O | B | CaO |
| | (m²/g) | (μm) | (μm) | D50/DP | D90/D10 | (mass %) | (mass %) | (mass %) | DL/DS | (%) | ppm | ppm |
| Ex. 1 | 0.7 | 2.06 | 4.5 | 2.2 | 2 | 0.003 | 0 | 0 | 1.6 | 0.02 | 150 | 850 |
| Ex. 2 | 0.7 | 2.18 | 4.7 | 2.15 | 1.9 | 0.002 | 0.1 | 0 | 1.5 | 0.02 | 150 | 850 |
| Ex. 3 | 0.7 | 2.06 | 4.1 | 2 | 2 | 0.004 | 0 | 0 | 1.7 | 0.02 | 150 | 980 |
| Ex. 4 | 0.6 | 2.35 | 5.2 | 2.19 | 2.3 | 0.006 | 0.2 | 0 | 1.8 | 0.02 | 180 | 850 |
| Ex. 5 | 0.8 | 1.98 | 3.8 | 1.93 | 2.1 | 0.002 | 0 | 0.2 | 1.6 | 0.02 | 150 | 850 |
| Ex. 6 | 0.7 | 2.12 | 4.1 | 1.91 | 1.8 | 0.002 | 0 | 0 | 1.6 | 0.02 | 150 | 850 |
| Comp. | 1.8 | 0.84 | 1.5 | 1.8 | 0.8 | 0.03 | 0 | 49.4 | 2.3 | 0.05 | 180 | 150 |
| Ex. 1 | | | | | | | | | | | | |
| Comp. | 1.1 | 1.33 | 4.2 | 3.15 | 3.9 | 0.1 | 2.1 | 4 | 2.5 | 0.03 | 2 | 150 |
| Ex. 2 | | | | | | | | | | | | |
| Comp. | 1.1 | 1.39 | 2.9 | 2.08 | 2.1 | 0.003 | 0 | 3.8 | 2.2 | 0.05 | 180 | 150 |
| Ex. 3 | | | | | | | | | | | | |
| Comp. | 1.3 | 1.18 | 3.4 | 2.87 | 3.1 | 0.04 | 0 | 8.4 | 1.7 | 0.02 | 150 | 850 |
| Ex. 4 | | | | | | | | | | | | |

TABLE 3

| | Ex. 7 | Ex. 8 | Comp. Ex. 5 | Comp. Ex. 6 |
|---|---|---|---|---|
| Flexural strength | 370 | 360 | 250 | 251 |
| (MPa) | | | | |

TABLE 4

| | Ex. 9 | Ex. 10 | Comp. Ex. 7 | Comp. Ex. 8 |
|---|---|---|---|---|
| Thermal resistance | 0.1 | 0.11 | 0.15 | 0.16 |
| (K · cm²/W) | | | | |

Measured at 35° C. (constant) under 0.7 MPa

### INDUSTRIAL APPLICABILITY

According to the present invention, affinity of the particulate alumina glass frit can be enhanced, thereby providing a glass-ceramic composition of high mechanical strength. In addition, rubber-based, plastic-based and silicone oil-based resin compositions containing the particulate alumina of the present invention exhibit high thermal conductivity. When the composition of the present invention is provided between a heat source and a radiator included in an electronic part or semiconductor device, there can be attained excellent performance (i.e., higher operational speed and higher resistance to load) as compared with those of conventional electronic parts and semiconductor devices.

1. Particulate alumina having a mean particle size corresponding to a volume-cumulative 50% mean particle size (D50) falling within a range of 3 to 6 μm, having a ratio of D90 to D10 that is 2.5 or less, containing particles that have a particle size of at least 12 μm in an amount of 0.5 mass % or less, particles that have a particle size of 20 μm or more in an amount of 0.01 mass % or less and particles that have a particle size of 1.5 μm or less in an amount of 0.2 mass % or less, and containing an α-phase as a predominant phase.

2. The particulate alumina according to claim 1, wherein it has a ratio of longer diameter (DL) to shorter diameter (DS) that is 2 or less and a ratio of D50 to mean primary particle size (DP) that is 3 or less.

3. The particulate alumina according to claim 1 or claim 2, wherein it contains Na₂O in an amount of 0.1% or less, B in an amount of at least 80 ppm and CaO in an amount of at least 500 ppm.

4. A method for producing particulate alumina, comprising the steps of adding, to aluminum hydroxide or alumina, a boron compound, a halide and a calcium compound to form a mixture and firing the mixture.

5. The method according to claim 4, wherein the halide is at least one species selected from the group consisting of aluminum halide, ammonium halide, calcium halide, magnesium halide and hydrogen halide.

6. The method according to claim 4 or claim 5, wherein the boron compound is at least one species selected from among boric acid, boron oxide and borate salts.

7. The method according to any one of claims 4 to 6, wherein the halide is at least one species selected from the group consisting of aluminum fluoride, aluminum chloride, ammonium chloride, ammonium fluoride, calcium fluoride, calcium chloride, magnesium chloride, magnesium fluoride, hydrogen fluoride and hydrogen chloride.

8. The method according to any one of claims 4 to 7, wherein the calcium compound is at least one species selected from the group consisting of calcium fluoride, calcium chloride, calcium nitrate and calcium sulfate.

9. The method according to any one of claims 4 to 8, wherein the boron compound is added in an amount, as reduced to boric acid, falling within a range of 0.05 to 0.50 mass % based on alumina; the calcium compound is added in an amount, as reduced to Ca, falling within a range of 0.03 to 0.10 mass % based on alumina; and the halide is added in an amount falling within a range of 0.20 to 0.70 mass % based on alumina.

10. The method according to any one of claims 4 to 9, wherein the step of firing is performed at a temperature falling within a range of 1,200 to 1,550° C. and for a maximum temperature retention time falling within a range of 10 minutes to 10 hours.

11. The method according to any one of claims 4 to 10, further comprising the step of crushing the fired mixture by means of an airflow pulverizer employing a nozzle jet gauge pressure falling within a range of 2×10⁵ Pa to 6×10⁵ Pa.

12. The method according to any one of claims 4 to 10, further comprising the step of crushing the fired mixture by means of a ball mill or a vibration mill employing alumina balls, followed by the step of removing microparticles by use of an airflow classifier.

13. A composition containing the particulate alumina of claim 1 in an amount of at least 10 mass % and not greater than 90 mass % and a polymer.

14. The composition according to claim 13, wherein the polymer is at least one species selected from aliphatic resin, unsaturated polyester resin, acrylic resin, methacrylic resin, vinyl ester resin, epoxy resin and silicone resin.

15. The composition according to claim 13, wherein the polymer is an oily substance.

16. The composition according to claim 13, wherein the polymer has a softening point or a melting point falling within a range of 40 to 100° C.

17. An electronic part or a semiconductor device containing the composition of claim 13 between a heat source and a radiator.
